(19) United States
(12) Patent Application Publication
(10) Pub. No.: US 2025/0230047 A1
(43) Pub. Date: Jul. 17, 2025

(54) DIMENSIONALLY STABLE AMORPHOUS CARBON STRUCTURES

(71) Applicant: UpNano GmbH, Wien (AT)

(72) Inventors: Jan TORGERSEN, Trondheim (NO); Kjetil Skar BAGLO, Trondheim (NO); Robert BOCK, Berlin (DE); Martin STEINERT, Trondheim (NO); Markus LUNZER, Vienna (AT)

(21) Appl. No.: 18/706,641

(22) PCT Filed: Nov. 3, 2022
(86) PCT No.: PCT/EP2022/080732

§ 371 Date: May 1, 2024

(30) Foreign Application Priority Data
Nov. 3, 2021 (GB) 2115802.7

(51) Int. Cl. C01B 32/05; B33Y 80/00; C08F 222/20; C09D 4/00; C09D 135/02

(52) U.S. Cl. CPC C01B 32/05; B33Y 80/00; C08F 222/20; C09D 4/00; C09D 135/02; C01P 2002/02; C01P 2006/40; C08F 2800/20; C08F 2810/20

(57) ABSTRACT

A process for the production of a geometrically predefined amorphous carbon structure, comprising: i) forming a geometrically predefined polymeric precursor structure; and ii) pyrolysing said geometrically predefined polymeric precursor structure so as to form said geometrically predefined amorphous carbon structure; wherein step i) comprises forming a geometrically predefined polymeric precursor structure on a substrate, said geometrically predefined structure comprising an at least partially cured photopolymer; and wherein the step ii) of pyrolysing said geometrically predefined polymeric precursor structure comprises: (a) holding the geometrically predefined polymeric precursor structure at a temperature in the range of 200° C. to 400° C. for a period of between 1 hour and 40 hours, preferably 5 hours to 20 hours; and (b) subsequently pyrolysing said geometrically predefined polymeric precursor structure at a temperature of 700° C. to 1200° C.

The present invention relates to geometrically predefined amorphous carbon structures and methods for the production thereof. The invention further relates to articles comprising geometrically predefined amorphous carbon structures and methods for the production of said articles.

### BACKGROUND

Amorphous carbon has been used extensively in electrochemical applications for its wide potential stability window, chemical inertness, low cost, low background currents and electrocatalytic activity. Often, such materials are produced by pyrolysing polymeric precursor materials, for example by heating them to a high temperature in an inert atmosphere. However, the fabrication of high quality amorphous carbon structures having complex geometries, especially larger structures, is very difficult using conventional methods. In particular, the fabrication of complex, geometrically predefined structures having a height of more than a few 100 μm has proved very difficult using conventional manufacturing methods.

More recently, additive manufacturing techniques such as 3D printing have been proposed for the fabrication of amorphous carbon structures. In B. Rezaei et al., Materials and Design 193 (2020) 108834, 3D carbon electrodes were prepared using stereolithography (SLA) printing technology followed by pyrolysis. However the polymeric precursor structures used to make these electrodes are formed of conventional polymeric resins which undergo a large amount of shrinkage on pyrolysis (greater than 50%). The resulting amorphous carbon structures are thus relatively small and have a high surface roughness caused by degassing during pyrolysis.

CN110483050A describes a light-cured 3D printed stepped porous carbon material. The carbon-rich 3D printing resin comprises a bisphenol A epoxy acrylate, diethylene glycol diacrylate and polyethylene glycol diacrylate. The material is dried in an oven at 80° C. for 6 hours, then put in a tube furnace in a nitrogen atmosphere at 240° C. for 3 hours followed by 700° C. for 3 hours.

There remains a need therefore for alternative methods for producing geometrically predefined amorphous carbon structures which have improved quality (e.g. low surface roughness) and which are capable of producing larger structures (i.e. having a lower surface area to volume ratio). The present inventors have now established that by using a tailored formulation to form a polymeric precursor structure comprising a cured photopolymer, and subsequently subjecting this structure to a tailored pyrolysis protocol, geometrically predefined amorphous carbon structures having the afore-mentioned advantages can be obtained, especially at sizes above 100 μm with sub μm resolution. Specifically, the inventors surprisingly established that certain cured photopolymers, in combination with tailored geometry and polymer specific pyrolisation programs, are ideally suited for pyrolysis as they retain stiffness during the pyrolysis process but become sufficiently diffusive to allow gases to diffuse out of the cured photopolymer during the pyrolysis process.

In this way, the process allows the production of high quality geometrically pre-defined amorphous carbon structures across multiple lengths and which have a low surface area to volume ratio and low surface roughness.

### SUMMARY OF THE INVENTION

In one aspect, the invention provides a process for the production of a geometrically predefined amorphous carbon structure, comprising:
i) forming a geometrically predefined polymeric precursor structure; and
ii) pyrolysing said geometrically predefined polymeric precursor structure so as to form said geometrically predefined amorphous carbon structure;
wherein step i) comprises forming a geometrically predefined polymeric precursor structure on a substrate, said geometrically predefined polymeric precursor structure comprising an at least partially cured photopolymer;
   wherein said cured photopolymer has a glass transition temperature (T_{g}) in ° C. and the geometrically predefined polymeric precursor structure has a heat degradation temperature (T_{d}) in ° C. such that T_{d} is at least 300° C. and T_{d} is greater than the T_{g}.

In a second aspect, the invention provides a process for the production of a geometrically predefined amorphous carbon structure, comprising:
i) forming a geometrically predefined polymeric precursor structure; and
ii) pyrolysing said geometrically predefined polymeric precursor structure so as to form said geometrically predefined amorphous carbon structure;
wherein step (i) comprises forming a geometrically predefined polymeric precursor structure on a substrate by curing a formulation comprising a monomer and photoiniator, e.g. a multifunctional oligomeric monomer and a photoinitiator;
   wherein said cured photopolymer has a glass transition temperature (T_{g}) in ° C. and the geometrically predefined polymeric precursor structure has a heat degradation temperature (T_{d}) in ° C. such that T_{d} is at least 300° C. and T_{d} is greater than the Tg.

Viewed from another aspect, the invention provides a process for the production of a geometrically predefined amorphous carbon structure, comprising:
i) forming a geometrically predefined polymeric precursor structure; and
ii) pyrolysing said geometrically predefined polymeric precursor structure so as to form said geometrically predefined amorphous carbon structure;
wherein step i) comprises forming a geometrically predefined polymeric precursor structure on a substrate, said geometrically predefined structure comprising an at least partially cured photopolymer;
and wherein the step of pyrolysing said geometrically predefined polymeric precursor structure comprises
(a) holding the geometrically predefined polymeric precursor structure at a temperature in the range of 200° C. to 400° C. for a period of between 1 hour and 40 hours, preferably 5 hours to 20 hours and (b) subsequently pyrolysing said geometrically predefined polymeric precursor structure at a temperature of 700° C. to 1200° C.

In particular the preferred process comprises:
i) forming a geometrically predefined polymeric precursor structure; and
ii) pyrolysing said geometrically predefined polymeric precursor structure so as to form said geometrically predefined amorphous carbon structure;
wherein step i) comprises forming a geometrically predefined polymeric precursor structure on a substrate, said geometrically predefined structure comprising an at least partially cured photopolymer obtained by curing a formulation comprising a monomer and a photoinitiator, in particular a multifunctional aromatic (meth)acrylate monomer and a photoinitiator;
and wherein the step of pyrolysing said geometrically predefined polymeric precursor structure comprises
(a) holding the geometrically predefined polymeric precursor structure at a temperature in the range of 200° C. to 400° C. for a period of between 1 hour and 40 hours, preferably 5 hours to 20 hours and (b) subsequent pyrolysing said geometrically predefined polymeric precursor structure at a temperature of 700° C. to 1200° C.

In another aspect, the invention provides a geometrically predefined amorphous carbon structure obtainable, preferably obtained, by a process according to any one of the aspects described herein.

In another aspect, the invention provides a geometrically predefined amorphous carbon structure having a surface area to volume ratio of 20.0 mm⁻¹ or less.

In another aspect, the invention provides an electrochemical flow device comprising a geometrically predefined amorphous carbon structure according to any one of the aspects described herein.

In another aspect, the invention provides an electrode assembly comprising a geometrically predefined amorphous carbon structure according to any one of the aspects described herein.

In another aspect, the invention provides a gas diffusion layer comprising a geometrically predefined amorphous carbon structure according to any one of the aspects described herein.

In another aspect, the invention provides a heat exchanger comprising a geometrically predefined amorphous carbon structure according to any one of the aspects described herein.

In another aspect, the invention provides a carbon sensor comprising a geometrically predefined amorphous carbon structure according to any one of the aspects described herein.

In another aspect, the invention provides a gasket comprising a geometrically predefined amorphous carbon structure according to any one of the aspects described herein.

In a further aspect, the invention provides a method for producing a component of an electrode assembly, preferably a gas diffusion layer, flow field plate or a microporous layer (or a consolidated part of a gas diffusion layer, flow field plate and/or a microporous layer) comprising a produced geometrically predefined amorphous carbon structure by a process according to any one of the aspects described herein.

### Definitions

The degradation temperature is the temperature where the geometrically predefined polymeric precursor structure deforms and loses its predetermined shape. This can be determined by heating the geometrically predefined polymeric precursor structure until deformation occurs. In one embodiment, the ramp temperature used to determine the degradation is 10° C. per minute until deformation occurs.

At the heat degradation temperature, the geometrically predefined polymeric precursor structure deforms under its own weight and hence loses its original shape and feature relationships. This can be determined using optical microscopy assessment of the dimensions.

### DESCRIPTION OF THE INVENTION

In one aspect, the present invention provides a process for the production of a geometrically predefined amorphous carbon structure. In particular, the process involves the use of a geometrically predefined polymeric precursor structure comprising a cured photopolymer where there is a particular relationship between glass transition temperature (T_{g}) in ° C. of the cured photopolymer and the heat degradation temperature of the geometrically predefined polymeric precursor structure.

Surprisingly, the present inventors have established that by using a cured photopolymer in which the T_{g} is below the T_{d} to form a geometrically predefined polymeric precursor structure, the subsequent pyrolysis step is improved and it is possible to fabricate high quality geometrically predefined amorphous carbon structures across a wide range of lengths (i.e. sub 100 nm to multi-cm or even meter lengths).

Without wishing to be limited by theory, it is envisaged that the use of a system having a T_{g} T_{d} relationship as defined herein gives rise to a geometrically predefined polymeric precursor structure which, when pyrolysed, is sufficiently diffuse that gases generated during pyrolysis are readily able to escape the geometrically predetermined shape without jeopardising the integrity of the predetermined shape. One problem with previous solutions is that the gases that are released during pyrolysis are trapped within the structure causing voids. This leads to structural distortions and ultimately to failure of the structure during pyrolysis.

The high heat degradation temperature of the geometrically predefined polymeric precursor structure (Td), is indicative of a material which resists deformation at high temperature and hence is one that ensures dimensional stability during carbonisation.

Because the Tg is lower than the Td, there is a large window in which pyrolysis can be effected successfully without causing dimensional instability but whilst allowing easy release of gases generated from the predetermined shape. Key, therefore, is that the geometrically predefined polymeric precursor structure is diffusive enough to allow volatile species to exit but stiff enough to retain its shape. If the gap between Tg and Td is large, there is more opportunity to find a temperature at which non-carbonizable species can be removed from the network whilst retaining dimensional network stability.

In a further aspect, the invention relates to a tailored pyrolisation process in which specific heat ramps and dwell times are used to control the pyrolysis process. The heat ramps and dwell times are of particular importance as they consider the chemical and kinetic processes at different stages of carbonization. In particular, ensuring the cured photopolymer is in a viscoelastic state that allows the diffusion of non-carbonizable species out of the network is vital.

In addition, the use of a cured photopolymer as defined herein results in the formation of amorphous carbon structures having advantageously low surface area to volume ratios (i.e. generally larger structures), but yet which are still of high quality. In another aspect therefore, the present invention relates to a geometrically predefined amorphous carbon structure having a surface area to volume ratio of 20.0 mm⁻¹ or less.

Some of the additional advantages of the process of the present invention are as follows:
high resolution i.e. the ability to reproduce features on the sub-100 nm scale
the ability to use a wide range of cured photopolymers (including ionic and radical polymerised resins)
the ability to use a wide range of fabrication technologies to form the polymeric precursor structure (e.g. two-photon polymerisation, digital light processing UV photopolymerisation, and stereolithography)
low surface roughness.

It is the technology and not the process that will determine the size range of the material. For example, two photon polymerisation can span from sub 100 nm to cm scale, whereas digital light/UV processing can span from <10 μm to m scale.

The geometrically predefined polymeric precursor structure preferably has at least one dimension of 100 μm or more, such as two such dimensions of 100 μm or more. A material with such a large dimension has less surface area to volume ratio and it takes longer the non carbonizable species have to diffuse out. It is therefore remarkable that the gases can be removed in the present case.

The geometrically predefined polymeric precursor structure may be a disc shape or layer shape (square or rectangular).

### Cured Photopolymer

The process for the production of a geometrically predefined amorphous carbon structure as described herein involves the use of at least one cured photopolymer having a particular glass transition temperature (T_{g}) in ° C.

A photopolymer is a polymer that changes its properties when exposed to light, often in the infrared, ultraviolet or visible region of the electromagnetic spectrum. In one embodiment, the photopolymer absorbs two or more photons of higher wavelengths in a process called multi photon absorption. These changes are often manifested structurally, for example curing of the material occurs as a result of exposure to light.

Surprisingly, when using a cured photopolymer in a geometrically predefined polymeric precursor structure having the required relationship of Tg to Td, it is possible to obtain geometrically predefined amorphous carbon structures having the afore-mentioned advantages e.g. in terms of size, quality and surface area to volume ratio.

Cured photopolymers of the invention do not have defined melting points (i.e. a temperature where the entire polymer network changes from a solid to a liquid state). The cured photopolymers do however possess a heat degradation temperature (Td).

The heat degradation temperature is measured on the geometrically predefined polymeric precursor structure as this is the material that needs to retain its shape during the pyrolysis step. An important property of the cured photopolymer is that the pyrolysis temperature or thermal decomposition temperature is reached at a temperature lower than the heat degradation temperature. The cured photopolymer should start to dissociate (release non-carbonizable species) below the degradation temperature. The pyrolysis temperature is the temperature at which the cured photopolymer carbonises. When this temperature is reached, thermal cracking reactions, heat and mass transfer occur and the polymer network releases volatile gases (H₂, CO, CO₂, CH₄, H₂O or longer chain hydrocarbons) leaving carbon (the remainder). Some parts of the cured photopolymer are not therefore converted into carbon and these dissociate and leave the network.

During the pyrolysis step, the cured photopolymer must be permeable enough to release volatile gases but stiff enough to retain its shape. We want therefore a cured photopolymer that is stable/stiff enough beyond Tg, over which it is in a viscoelastic state. Furthermore, we want a cured photopolymer, where degradation (Td) occurs at high temperatures, such that we have a range of feasible temperatures for pyrolysis in the amorphous state beyond Tg.

Depending on the constituents of the cured photopolymer, the properties of Tg as well as the stability of the cured photopolymer beyond Tg will vary and the pyrolysis protocol can be adapted. It is preferred if
the Tg is far below Td in temperature, e.g. at least 100° C. lower;
the Td is high, e.g. 350° C. or more;
the cured photopolymer is diffusive to non-carbonizable species beyond Tg;
the cured photopolymer is stiff beyond Tg.

This combination of features gives a network that can be carbonized to stable structures with a higher volume to surface area (where volatiles have to travel longer distances).

The glass transition temperature is a fundamental property of a material that represents the temperature at which an amorphous material (or amorphous domains in a semi-crystalline material) transitions from a hard and relatively brittle “glassy” state into a more viscous “rubbery” state as the temperature is increased. Viewed in another way, it is also the temperature at which an amorphous material transitions from a relatively viscous “rubbery” state into a more brittle “glassy” state as the temperature is decreased.

The glass transition temperature of a given material can be measured in a number of ways. Such methods are well-known in the art and include thermomechanical analysis (TMA), dynamic mechanical analysis (DMA) and differential scanning calorimetry (DSC). As used herein, the glass transition temperature (T_{g}) refers to the glass transition temperature of the photopolymer as measured by DSC according to ISO11357-2. The Tg of interest herein is the transition temperature found by inflection point, using the DSC curve. The T_{g} of the photopolymer refers to that of the cured photopolymer.

The heat degradation temperature is measured on the geometrically predefined polymeric precursor structure. The heat degradation temperature is the temperature at which the geometrically predefined polymeric precursor structure deforms.

In order to be diffusive enough for non-carbonisable species to exit the network during pyrolysis, the cured photopolymer has to undergo a glass transition. However, it is also important that the network has enough thermal stability past the glass transition temperature, i.e. the heat degradation temperature is sufficiently high. Without wishing to be bound by theory, it is believed that the relationship of T_{g} to T_{d} as described above ensures a balance between these two considerations.

In a preferred embodiment, the T_{g} of the cured photopolymer is in the range of 80° C. to 200° C., preferably in the range of 80° C. to 150° C., more preferably in the range of 80° C. to 130° C.

In a preferred embodiment, the T_{d} of the geometrically predefined polymeric precursor structure is in the range of 300° C. to 550° C., preferably in the range of 350° C. to 500° C., more preferably in the range of 375° C. to 450° C.

It will be appreciated that the relevant component of the geometrically predefined polymeric precursor structure is the cured photopolymer. In essence therefore the Td of the cured photopolymer is also in the range of 300° C. to 550° C., preferably in the range of 350° C. to 500° C., more preferably in the range of 375° C. to 450° C.

Ideally the T_{d} should be at least 200° C. more than the Tg, such as at least 250° C. more than the Tg, e.g. 200 to 500° C. more than the Tg.

It has been observed that when the T_{g} and Td are in the ranges described above, the subsequent pyrolysis of the polymeric precursor structure is surprisingly improved (e.g. in terms of diffusion and dimensional stability). Without wishing to be bound by theory, it is believed that having a Td and T_{g} within these ranges allows for the activation energy for the scission of functional groups in the cured photopolymer to be hit, enabling them to exit the network during pyrolysis (e.g. by diffusion) before the polymer begins to deform.

Preferably, the cured photopolymer is a thermoset. Such polymers have been observed to lead to better dimensional stability of the structure upon pyrolysis. Without wishing to be bound by theory, whilst a thermosetting polymer is usually undesirable in many applications (typical characteristics are brittleness, lack of plasticity), it is believed that the use of a thermoset polymer in this case is advantageous because it allows for non-carbonisable species to exit the network during pyrolysis whilst the network remains dimensionally stable.

In general, any cured photopolymer may be used in the process of the present invention, provided that it has the required T_{g}: T_{d} relationship.

### Preparation of the Cured Photopolymer

The cured photopolymer is prepared from a formulation comprising the requisite monomers, a photoinitiator and optional addition components. The monomer mixture may be regarded as the “photopolymer” herein. In particular, the monomer mixture comprises an oligomeric monomer and optionally the reactive diluent. At least one monomer present must be multifunctional, e.g. bi or trifunctional. The multifunctional monomer used may also be called the crosslinker or crosslinking agent herein.

Ideally, the formulation from which the cured photopolymer is prepared may comprise a multifunctional monomer (such as an oligomeric multifunctional monomer), a photoinitiator and optionally reactive diluents. Ideally, the formulation is liquid at room temperature.

The formulation is subjected to electromagnetic radiation to start the polymerisation and curing process, and a cured photopolymer is prepared that is solid at room temperature. The use of a mould or 3D printing ensures that it is in its intended geometric shape at this time, i.e. that a geometrically predefined polymeric precursor structure is formed.

The photopolymer is cured (i.e. the formulation comprising at least one crosslinker is photocured) at the same time as the polymerisation occurs—these processes can be seen as occurring simultaneously. Polymerization is the process in which a polymer is formed by bonding together multiple identical units (monomers) while crosslink is a covalent bond (or series of bonds) between adjacent chains of a polymer. Crosslinks form when the initial formulation is exposed to radiation and as the monomers start to react with each other to form a complex network. In a preferred embodiment, the crosslinking reaction occurs when the formulation is exposed to electromagnetic radiation, such as UV, IR or visible light. The degree of crosslinking in the cured photopolymer may be partial (i.e. partially cured) or essentially complete (i.e. fully cured).

The photopolymer is preferably based on a (meth)acrylate monomer, glycidyl ether monomer, thiol monomer, alkyne monomer, alkene monomer, or vinyl monomer or mixture thereof. In particular, the photopolymer might be based on a (meth)acrylate monomer or glycidyl ether monomer. The monomer itself may be oligomeric. A single monomer may be used or a mixture of monomers.

In a preferred embodiment, the photopolymer is based on an oligomeric monomer unit, i.e. one that contains a repeating unit itself. Conveniently that repeating unit is an alkylene glycol such as PEG. In general, such oligomers are capable of polymerising and curing, i.e. reacting with other oligomers to form a crosslinked network. Typically, the photopolymer may be formed by radical or ionic polymerisation, preferably radical polymerisation. Cured photopolymers are preferably prepared from formulations containing at least a photoinitiator and an oligomeric monomer using electromagnetic radiation.

In a preferred embodiment, the formulation comprises multifunctional oligomer monomers. In an especially preferred embodiment, the photopolymer comprises oligomeric (meth)acrylate monomers, preferably multifunctional oligomeric (meth)acrylate monomers, such as oligomers comprising two or more acrylic or methacrylic functional groups. In particular a preferred multifunctional monomer comprises aromatic groups and two or more acrylic or methacrylic functional groups.

In another embodiment, the photopolymer comprises glycidyl ether functionalised oligomers. In a preferred embodiment, the cured photopolymer is formed from a (meth)acrylic resin formulation, more preferably an acrylic resin.

The multifunctional monomer used to make the cured photopolymer of the invention (also called the crosslinker or crosslinking agent herein) is preferably aromatic. It should comprise C, H and O content and ideally no other atoms. The more C present the better.

For example, aromatic di(meth)acrylates or aromatic diglycidyl ethers, e.g. bisphenol derived di(meth)acrylates as well as bisphenol derived diglycidyl ethers are preferred.

Specific cured photopolymers of interest include styrene/oligomeric acrylate photopolymers, e.g.

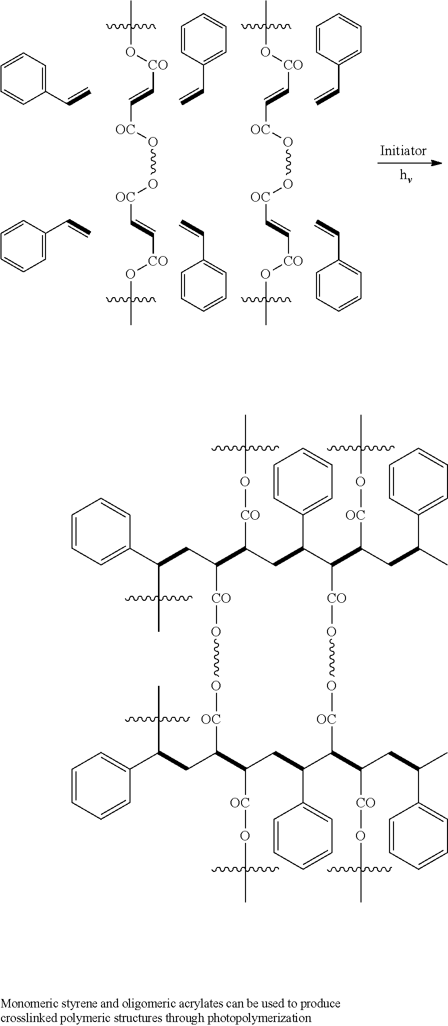

A more preferred monomer is based on a bisphenol structure. In a most preferred embodiment, the cured photopolymer is one prepared using a crosslinker such as bisphenol di(meth)acrylate, especially an alkoxylated bisphenol di(meth)acrylate, such as ethoxylated bisphenol A di(meth)acrylate.

The degree of ethoxylation is ideally kept to a minimum to have the highest possible C/O ratio and aromatic content. Ethoxylation makes the formulation less viscous and soluble in solvents.

Suitable monomers are those of formula:

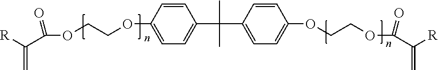

where each n is 0 to 40, such as 2 to 30, preferably 3 to 10 and each R is H or methyl, preferably H. Ideally, both Rs are the same. Preferably both n's are the same.

The viscosity of the cured photopolymer can be reduced through the addition of mono functional monomers (called the reactive diluent herein) such as benzyl acrylate or styrene. The reduction in viscosity makes the material easier to 3D print and allows further tuning of the C/O ratio and the aromatic content. The use of a reactive diluent also improves reactivity. Typically, the cured photopolymer comprises at least carbon and oxygen atoms. In a preferred embodiment, the cured photopolymer has a relatively high ratio of carbon atoms to oxygen atoms. For example, in one embodiment, the cured photopolymer has a number ratio of carbon atoms to oxygen atoms (C/O) of at least 2:1, preferably at least 3:1, more preferably at least 4:1. In one embodiment, the cured photopolymer has a C/O ratio of at least 8:1, more preferably at least 10:1. In a preferred embodiment therefore, the cured photopolymer has a C/O ratio of between 2:1 and 20:1, preferably 6:1 to 20:1, more preferably 10:1 to 20:1.

The ratio is measured by counting the number of oxygen and carbon atoms in the different monomers and weighting it by the molar fraction of the monomer. The sum of the weighted oxygen and carbon content is then used to calculate the O/C fraction.

Generally, the cured photopolymer comprises at least carbon and hydrogen atoms. In a preferred embodiment, the cured photopolymer has a relatively high ratio of carbon atoms to hydrogen atoms. For example, in one embodiment, the photopolymer has a number ratio of carbon atoms to hydrogen atoms (C/H) of at least 1:3, preferably at least 1:2, more preferably at least 1:1. In one embodiment, the cured photopolymer has a C/H ratio of up to 3:1, preferably up to 2.5:1, more preferably up to 2:1. In a preferred embodiment therefore, the cured photopolymer has a C/H ratio of between 1:3 and 3:1, preferably 1:2 to 2.5:1, more preferably 1:1 to 2:1.

In a preferred embodiment, the cured photopolymer has a carbon content of at least 30 atomic % (at. %), preferably at least 40 at. %, more preferably at least 50 at. %. In another embodiment, the photopolymer has a ratio of sp² to sp³ hybridised carbon atoms of at least 1:2, preferably at least 1:1, more preferably at least 2:1. In a preferred embodiment, the cured photopolymer comprises aromatic groups.

Whilst not essential, the use in the inventive process of a cured photopolymer comprising a relatively high ratio of sp² to sp³ hybridised carbon atoms as described above has been observed to lead to amorphous carbon structures having better feature definition, stability and quality. Without wishing to be bound by theory, this improvement is believed to be due to the fact that by having a relatively high ratio of sp² to sp³ hybridised carbon atoms (e.g. by having a high aromatic content), the cured photopolymer is in a more favourable arrangement for the subsequent conversion to amorphous carbon during the pyrolysis step.

In one embodiment, the cured photopolymer comprises at least carbon, hydrogen and oxygen atoms. In a preferred embodiment, carbon, hydrogen and oxygen atoms form at least 90 wt % of the cured photopolymer. In one preferred embodiment, the cured photopolymer consists essentially of (i.e. at least 95 wt %, preferably at least 99 wt %) carbon, hydrogen and oxygen atoms. In a preferred embodiment, the cured photopolymer consists of carbon, hydrogen and oxygen atoms.

In one embodiment the cured photopolymer comprises, e.g. consists of, carbon, hydrogen, nitrogen and oxygen atoms.

In one embodiment, the cured photopolymer has a Young's modulus (E) of at least 2 GPa, preferably at least 3 GPa, more preferably at least 4 GPa. In a preferred embodiment, the cured photopolymer has a Young's modulus in the range of 2 GPa to 8 GPa, preferably in the range of 3 GPa to 7 GPa, more preferably in the range of 4 GPa to 6 GPa.

In one embodiment, the cured photopolymer has a Poisson ratio in the range of 0.1 to 0.5, preferably in the range of 0.15 to 0.4, more preferably in the range of 0.2 to 0.3.

In one embodiment, the cured photopolymer has a thermal conductivity of at least 0.1 Wm⁻¹K⁻¹, preferably at least 0.15 Wm⁻¹K⁻¹, more preferably at least 0.2 Wm⁻¹K⁻¹. In a preferred embodiment, the cured photopolymer has a thermal conductivity in the range of 0.1 to 0.5 Wm⁻¹K⁻¹, preferably 0.15 to 0.4 Wm⁻¹K⁻¹, more preferably 0.2 to 0.3 Wm⁻¹K⁻¹.

In one embodiment, the cured photopolymer has a density in the range of 900 to 1500 kg/m³, preferably in the range of 1000 to 1400 kg/m³, more preferably in the range of 1100 to 1300 kg/m³.

In one embodiment, the cured photopolymer has a resistivity of at least 5 Ωm, preferably at least 8 Ωm, more preferably at least 10 Ωm. In a preferred embodiment, the photopolymer has a resistivity in the range of 5 to 20 Ωm, preferably 8 to 15 Ωm, more preferably 10 to 12 Ωm.

In one embodiment, the cured photopolymer has a thermal expansion coefficient (α) in the range of 10⁻⁶ to 10⁻² K⁻¹, preferably in the range of 10⁻⁵ to 10⁻³ K⁻¹, more preferably in the range of 5×10⁻⁵ to 5×10⁻⁴ K⁻¹.

### Reactive Diluent

A reactive diluent may also therefore be present during the preparation of the cured photopolymer. The reactive diluent is monofunctional and serves to reduce the viscosity and increase the reactivity of the cured photopolymer by reducing the degree of crosslinking. Examples of such reactive diluents include styrene, phenyl glycidyl ether, alkyl glycidyl ether (number of carbon atoms in alkyl group: 1 to 16), glycidyl ester of versatic acid (R¹ R² R³ C—COO-Gly, where R¹ R² R³ are alkyl groups such as C8 to C10 alkyl and Gly is a glycidyl group), olefin epoxide (CH₃—(CH₂) n-Gly, wherein n=11 to 13, Gly: glycidyl group), and C1-20-alkylphenyl glycidyl ether (preferably C1-5 alkylphenylglycidyl ether), e.g., methylphenyl glycidyl ether, ethylphenyl glycidyl ether, propylphenyl glycidyl ether and glycidyl neodecanoate.

More preferably, the reactive diluent is a monofunctional (meth)acrylate such as an alkyl or aryl (meth)acrylate e.g. benzyl acrylate. It is possible to use a mixture of reactive diluents. The use of an aromatic reactive diluent, such as an aromatic (meth)acrylate is especially preferred.

If a reactive diluent is present then preferably the weight ratio of reactive diluent to crosslinker is 30:70 to 5:95.

Photopolymers of interest also include polysiloxanes and polyurethanes.

### Photoinitiator

As well as the monomer and optional reactive diluent, the formulation used to prepare the cured photopolymer may contain a photoinitiator. Typically, the purpose of a photoinitiator is to generate reactive species upon exposure to radiation, e.g. light, that goes on to activate polymerisation of the monomers. In one embodiment, the photoinitiator is an ionic photoinitiator, i.e. it generates reactive ionic species upon exposure to electromagnetic radiation. In another embodiment, the photoinitiator is a radical photoinitiator, i.e. it generates free radicals upon exposure to electromagnetic radiation. Suitable ionic and radical photoinitiators are well known to the person skilled in the art and may be obtained from commercial sources. Preferably, the photopolymer comprises a radical photoinitiator.

The use of phenylbis(2,4,6 trimethylbenzoyl) phosphine oxide or Irgacure 290 is preferred.

The formulation used to prepare the cured photopolymer of the invention preferably comprises 0.1 to 2 wt % of the photoinitiator. Preferably at least 90 wt %, such as at least 95 wt % of the formulation comprises the crosslinker (monomer) and reactive diluent combined.

### Other Additives

The formulation used to prepare the geometrically predefined structure may also contain solvents including cyclopentanone.

The formulation used to prepare the geometrically predefined structure (and hence the geometrically predefined structure itself) may also contain a filler, especially a carbon filler including carbon nanotubes, graphene flakes and graphite powder. Fillers may form 1 to 20 wt % of the geometrically predefined structure.

The formulation used to prepare the geometrically predefined structure may also contain an absorber. To allow for better processability during the formation of the geometrically defined structure, 0.2 wt % Sudan orange absorber (CAS 2051-85-6) can be added.

The formulation comprising monomer and photoinitiator and any optional additional components is preferably liquid at room temperature or solid at room temperature but liquid at an elevated temperature at which the geometrically predefined structure is prepared. If the formulation is solid, it is only processable by two photon polymerization.

### Geometrically Predefined Polymeric Precursor Structure

The inventive process as defined herein comprises the step (i) of forming a geometrically predefined polymeric precursor structure. The step (i) further comprises the steps of forming a geometrically predefined structure on a substrate. The formation and curing of the cured photopolymer can be regarded as occurring simultaneously as the polymerisation process progresses.

As used herein, the term “polymeric precursor structure” is used to refer to the cured polymer-based structure comprising the at least partially cured photopolymer formed on the substrate before pyrolysis i.e. before the conversion of the structure to amorphous carbon in step ii).

The polymeric precursor structure is prepared via the polymerisation of a formulation comprising suitable monomers and optional reactive diluent to form the cured photopolymer in the presence of a photoinitiator. Optionally, the formulation may also comprise other components such as photosensitisers, solvents, fillers and light absorbers as described above. These may also form part of the geometrically predefined polymeric precursor structure.

In one embodiment, the geometrically predefined polymeric precursor structure therefore comprises components in addition to the cured photopolymer. In another embodiment, the at least one cured photopolymer is the sole polymer component of the geometrically predefined polymeric precursor structure.

In another embodiment, the at least one cured photopolymer forms at least 90 wt % of the geometrically predefined polymeric precursor structure. In one embodiment, the geometrically predefined polymeric precursor structure comprises at least 95 wt %, preferably at least 99 wt % of the at least one cured photopolymer, preferably consists of the cured photopolymer.

If filler is added then the weight contribution of the cured photopolymer to the polymeric precursor structure is reduced. The presence of solvent may also reduce the weight contribution of the cured photopolymer to the geometrically predefined polymeric precursor structure. In one embodiment, the above percentages can be regarded as dry weight percentages, i.e. ignoring the contribution of any solvent (which is immediately volatised during pyrolysis anyway).

The polymeric precursor structure formed in step i) is geometrically predefined. As used herein in relation to the polymeric precursor structure, the term “geometrically predefined” means that the polymeric precursor structure has a shape which is predetermined e.g. is set before the polymeric precursor structure is actually formed. The geometric shape is retained during carbonization where the structure shrinks predictably losing some of its weight but keeps is geometry (i.e. the geometric relations of features within a predictable range—this is not therefore deformation).

### Formation of the Polymeric Precursor Structure

In a preferred embodiment, the polymeric precursor structure is formed according to a computer-aided design (CAD) drawing. In this case, the process optionally further comprises the step of creating a CAD drawing and then forming the polymeric precursor structure according to this CAD drawing. Generally speaking, the polymeric precursor structure thus formed has a shape which is substantially identical to the predetermined shape e.g. as embodied in the CAD drawing.

The manufacturing technique used to form the geometrically predefined polymeric precursor structure is not particularly limited provided that it can produce the desired feature sizes and is compatible with the formulation comprising the monomer(s) and photoiniator. In one embodiment, the geometrically predefined polymeric precursor structure is formed by an additive manufacturing method, such as by 3D printing. In another embodiment, the geometrically predefined polymeric precursor structure is formed by two-photon polymerisation, digital light processing UV photopolymerisation, or stereolithography. In a preferred embodiment, the predefined polymeric precursor structure is formed by 3D printing.

In one embodiment, the step of forming said geometrically predefined polymeric precursor structure comprises the steps of:
a) forming on a substrate, a layer of material comprising the formulation as hereinbefore defined;
b) selectively projecting light from a light source onto said layer, e.g. via a digital micromirror device, causing said layer to at least partially cure in the areas of said layer exposed to said light; and
c) optionally repeating steps a) and b).

In one embodiment, the step of forming said geometrically predefined polymeric precursor structure comprises the steps of:
a) forming on a substrate, a predetermined structure comprising the formulation as hereinbefore defined;
b) selectively projecting light from a light source onto said layer, e.g. via a digital micromirror device, causing said layer to at least partially cure in the areas of said layer exposed to said light; and
c) optionally repeating steps a) and b).

It may of course be that the predetermined structure or shape is developed by applying layer of formulation with curing and then applying another layer of formulation and curing etc.

The step of forming the geometrically predefined polymeric precursor structure comprises forming a geometrically predefined structure on a substrate, said geometrically predefined structure comprising at least one cured photopolymer. The cure may be partial or complete. The formulation comprising the monomer and photoinitiator is therefore irradiated to form said cured photopolymer. The choice of substrate is not particularly limited so long as it is capable of supporting the structure and is inert. Preferably the substrate is also selected such that the structure may be easily released from the substrate after pyrolysis. The substrate should also withstand the pyrolysis temperature. Ceramic substrates might therefore be used.

The step of irradiating the formulation preferably comprises exposing the formulation to electromagnetic radiation such as visible light, UV, or IR. By irradiating the formulation, the photopolymer is formed and at least partially cures (i.e. to form crosslinks). The effect of this curing is that the geometrically predefined structure “sets” so as to form a stable, solid geometrically predefined polymeric precursor structure which can then subsequently be pyrolysed.

In a preferred embodiment, the geometrically predefined structure is essentially fully cured during production (i.e. the polymeric precursor structure has a high crosslinking density). Without wishing to be bound by theory, it is believed that a high crosslinking density ensures that the density of carbon is favourable for an arrangement as amorphous carbon during the subsequent pyrolysis step. However, the crosslinking density should not exceed a value where it prevents the diffusion of non-carbonizable species at elevated temperatures beyond T_{g}.

In one embodiment, the process further comprises a post-bake step, such as a UV post bake. Preferably, the post-bake takes place after the formation of the geometrically predefined polymeric precursor structure but before the pyrolysis step. In case some of the monomers remain unreacted, the UV post bake step subjects the geometrically predefined polymeric precursor structure to a further irradiation step to complete the curing process.

### Pyrolysis

The process of the present invention further comprises the step ii) of pyrolysing the geometrically predefined polymeric precursor structure so as to form a geometrically predefined amorphous carbon structure.

During the pyrolysis process, the photopolymer shrinks isotropically (or at least with predictable changes in all directions) but retains its shape. Gaseous species are released that are either not carbon (O, H based) or cannot be carbonized (CO₂, hydrocarbons) as their rearrangement to carbon is not favourable.

The resulting material is typically amorphous carbon with a predefined shape.

As used herein, the term “pyrolysing” refers to heating the geometrically predefined polymeric precursor structure formed in step i) to a temperature at which the components of the polymeric precursor structure start to decompose. Preferably, the heating is conducted in an atmosphere free of oxygen such as an inert atmosphere (e.g. argon, nitrogen) so as to prevent oxidation of the polymeric precursor structure.

In one embodiment, the step of pyrolysing said geometrically predefined polymeric precursor structure comprises at least one step of heating the geometrically predefined polymeric precursor structure to a temperature in the range of 700° C. to 1200° C. In a preferred embodiment, the geometrically predefined polymeric precursor structure is heated in at least one step to a temperature of at least 900° C., such as 900 to 1000° C. Recommended ramp is in the range 5 to 20° C./min. The dwell time at this temperature may be 1 hr to 24 hrs. For lower surface area to volume ratio materials, even longer dwells can be used, e.g. up to 40 hrs. The person skilled in the art can identify preferred dwell times as at the end of the dwell mass loss should stagnate, e.g. no further mass loss is occurring.

It is important during pyrolysis that the polymeric precursor structure goes into the rubbery phase (i.e. that the cured photopolymer is heated to above its glass transition temperature) and maintains its mechanical stability in this phase while it is diffusive enough for non-carbonizable species to exit.

In a preferred embodiment, the step of pyrolysing said geometrically predefined polymeric precursor structure comprises multiple heating steps. In a first step, the geometrically predefined polymeric precursor structure is heated to a temperature in the range of 200° C. to 400° C. (typically in this temperature range most non-carbonisable species are lost) and held substantially at that temperature for a period of time (the first hold temperature). The ramping to the required temperature is important as if the ramp is too rapid, the structure deforms. Recommended ramp is in the range 0.5 to 5 C/min, such as 1 to 3° C. per min. The hold time may be 1 to 40 hrs, such as 10 to 24 hrs. The ramp speed is a function of the surface area to volume ratio and can be adapted by the skilled person as required.

In a preferred embodiment, the step of pyrolysing said geometrically predefined polymeric precursor structure comprises holding the geometrically predefined polymeric precursor structure at a temperature in the range of 200° C. to 400° C. for a period of between 1 hour and 40 hours, preferably 5 hours to 20 hours. The duration of the pyrolysis step may depend on the surface area to volume ratio: higher ratio, shorter time. Ideally the hold temperature is between 300 to 350° C.

Without wishing to be limited by theory, the step of pyrolysing said geometrically predefined polymeric precursor structure may comprise holding the geometrically predefined polymeric precursor structure at a temperature determined by the transition between diffusional domains separated by distinct activation energies, which may be determined from an Arrhenius plot.

In one embodiment, the step of pyrolysing said geometrically predefined polymeric precursor structure comprises holding the geometrically predefined polymeric precursor structure at a first lower temperature before heating the geometrically predefined polymeric precursor structure to a second higher temperature. In this embodiment, the first lower temperature is preferably in the range of 200 to 400° C. Typically in this embodiment, the second higher temperature is in the range of 700 to 1200° C. In one embodiment, the second higher temperature is at least 900° C.

In one embodiment, the step of pyrolysing said geometrically predefined polymeric precursor structure comprises holding the geometrically predefined polymeric precursor structure at a first lower temperature before heating the geometrically predefined polymeric precursor structure to a second higher temperature in a so called flattening step and then heating to a third still higher temperature. In this embodiment, the first lower temperature is preferably in the range of 200 to 400° C. as hereinbefore described. Typically in this embodiment, the second higher temperature is up to 100° C. higher than the first hold temperature (but must be higher than the first hold temperature. During this second heating step the geometrically predefined polymeric precursor structure (or forming amorphous carbon structure) may be flattened using a compressing mechanism, e.g. by holding the material between two plates. The ramping to the required temperature is again important as if the ramp is too rapid, the structure melts. Recommended ramp is in the range 0.5 to 5 C/min, such as 1 to 3° C. per min. The flattening process may be short, e.g. up to 1 hr.

Subsequently, the third heating temperature is in the range of 700 to 1200° C. In one embodiment, the second higher temperature is at least 900° C.

Between any heating step, the material may be cooled.

In one embodiment, the process comprises the step of removing the support. In a preferred embodiment, the support is removed after the pyrolysis step. In an alternative embodiment, the support is removed before the pyrolysis step but after the step of forming the geometrically predefined polymeric precursor structure.

One problem is that the geometrically predefined polymeric precursor structure may creep or buckle during pyrolysis. To avoid this issue it is preferred if the structure is heated up above the T_{g} to an area of large weight loss. It may also be kept between two supports, such as two carbon fibre mats, to retain its flatness.

It is then cooled down and placed between two plates and heated up again to around the degradation temperature (T_{d}), at which point it becomes soft and flattens due to the pressure from the plates. Key here is that the volatile species are removed in the first step before flattening occurs.

The structure is cooled down and removed from the plates, placed between the carbon fibre mats again and heated up, e.g. to at least 900° C. to complete carbonization.

For example, the pyrolysis protocol may involve these steps:
1. The geometrically predefined polymeric precursor structure is suspended between two supports, such as carbon fiber bundles, mats, or similar, and heated in an inert atmosphere to the range where the largest weight loss occurs (e.g. 300 to 400° C.)—this is the hold temperature.
2. It is left for several hours e.g. 10-24 h at this temperature which results in a charred polymeric structure. The ramping to the required temperature is important as if the ramp is too rapid, the structure deforms. Exposure to oxygen in this initial step also causes the structure to oxidise. Recommended ramp is in the range 0.5 to 5 C/min, such as 1 to 3° C. per min.
3. The structure is then cooled and reheated between two thermally conductive plates, ideally back to at least the hold temperature of step 1. However, the reheat temperature range here may be from the hold temperature to 100° C. above the hold temperature, the higher the temperature the softer the pyrolysed material gets and the quicker it flattens, but there is increased risk of degradation and warping in the XY plane with higher temperature. Ideally, this step should be performed in inert atmosphere. A usual reheat hold time is 5-15 minutes. Recommended ramp is in the range 0.5 to 5 C/min, such as 1 to 3° C. per min. At the end of this step all volatile species have been removed.
4. The resulting flat partially graphitized structure may be kept between the thermally conductive plates and heated in inert atmosphere to 900° C. or more.

A preferred heating program is therefore:
1. 2-5° C./min ramp to the holding temperature in step 1 (300 to 400° C.)
2. 0.5-3° C./min ramp to second holding temperature up to 100° C. higher than hold 1 to the end of the weight loss regime (e.g. 400-500 C) 3. 10° C. ramp from step 2 to 900° C. or more.

A most preferred heating program is:
1. 2-5° C./min ramp to the holding temperature of 200 to 400° C., preferably 300 to 400° C.;
2. Hold at the holding temperature for 1 to 40 hrs, such as 8 to 20 hrs;
3. 0.5-7.5° C./min ramp from the holding temperature, such as 0.5 to 5° C./min ramp, to a temperature in the range of 450 to 600° C.;
4. 2.5 to 10° C./min ramp from the temperature in step 3 to 900° C. or more. Ideally, the heating in step 4 is the same as or faster than the ramp in step 3.

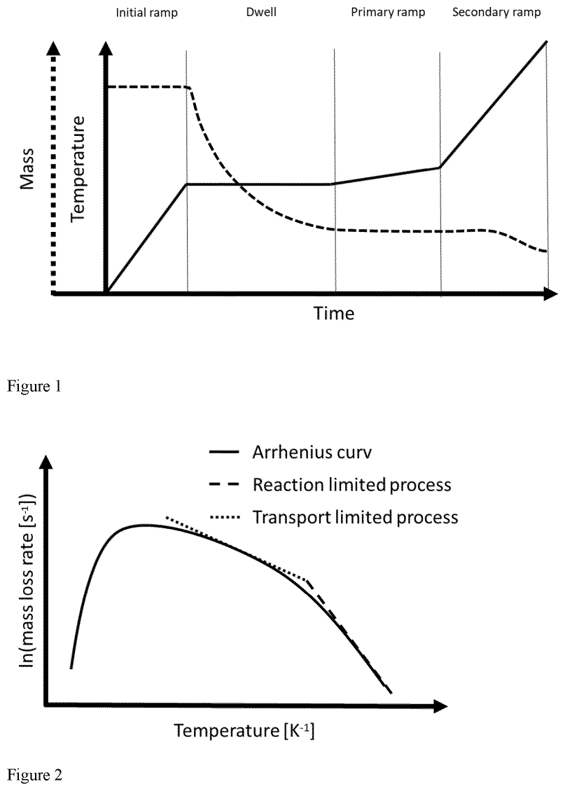

For example, a generic pyrolysis protocol is illustrated in FIG. 1. The initial ramp is not critical but the transition to the holding temperature must be slow to prevent overshooting, example 2° C./min. There is limited mass loss during this ramp. A holding temperature close to the temperature where the transport of exiting gases limits the process is the next step as the transport of exiting gases may cause a loss of stiffness through plasticising effects or geometrical instabilities caused by bubble formation.

A holding temperature or slow ramp (isothermal or semi-isothermal step) in the region of large weight loss is therefore desired.

During pyrolysis the geometrically predefined precursor structure is carbonised. This process requires the emission of volatile gases and the transport of such gases out of the precursor structure causes instabilities during the pyrolysis reaction. It is desirable that the process limiting the speed of the polymer's conversion to carbon is dominated by the reaction by which the polymer degrades.

At some temperature, the rate of generation of reaction products may be higher than the transport of reaction products, making the process transport limited. The holding temperature is ideally near the temperature where the transport of reaction products starts to limit the rate of conversion to carbon.

The onset of the holding temperature may be estimated by the transition between diffusional domains separated by distinct activation energies, which may be determined from an Arrhenius plot, FIG. 2. The holding temperature is that where the two lines (reaction and transport) intersect when the plot is recorded at semi-isothermal conditions.

The geometrically predefined polymeric precursor structure is held at that holding temperature for the time required to reach full or partial depletion of the degradation reaction (the dwell). This is precursor and geometry dependent. The ideal scenario is that the reaction is depleted and mass loss stops. However we have observed that also a partial depletion, for instance 50% mass loss or 80% mass loss (e.g. when the mass loss at desperation is 80%), can be enough.

It is not always required to fully deplete the structure, especially if the transport distance is small.

Typical values for an acrylic system in the form of a 1 mm thick cylindrical rod can be 14 hours at 350° C., 6 hours at 360° C., or 24 hours at 240° C. The duration of the dwell is typically such that mass loss from the geometrically predefined polymeric precursor structure stagnates, e.g. mass loss stops at the end of the dwell.

The duration of the dwell may depend on the distance volatile species that are generated during the pyrolysis reaction have to travel to exit the network (the so called diffusion length).

There is a temperature range (e.g. 320-650° C.), where the highest weight loss occurs. In this range, the ramp must be slow (or alternatively the geometrically predefined polymeric precursor structure might be periodically held at a specific temperature) to ensure that gases can escape without threatening the integrity of the structure. After a certain time (or a certain state of conversion), the ramp can increase again, optionally first only to a modest rate (primary ramp) and then to a steeper one (secondary ramp). The necessity of the primary ramp depends on the extent of the depletion (volatile gas elimination), with a slower ramp (example 0.5° C./min) needed for a low depletion, while the step may be skipped all to gather for a large extent of depletion.

In FIG. 1, a generic temperature program and mass loss is shown. An example of the heating rates and isothermal steps is: 2° C./min to 350° C. and hold for 14 hours, followed by a primary ramp of 0.5° C./min to 500° C. followed by a secondary ramp of 10° C./min to 1000° C.

The y axis in FIG. 1 represents the temperature and mass loss of the geometrically predefined polymeric precursor structure. A 0% mass represents the entire part being converted to volatile components leaving no remnants of the geometrically predefined polymeric precursor structure.

The overall goal is a process that is reaction limited and not transport limited, giving the volatile species enough time to diffuse out of the geometrically predefined polymeric precursor structure. This means that the lower the surface to volume ratio, the longer the hold time has to be and the more careful the ramp has to be. However, at higher temperatures, higher ramps are beneficial as the only volatile species left is hydrogen, which does not have transport issues penetrating the geometrically predefined polymeric precursor structure. This means that higher rates are not only possible but also preferred as it is important to keep the dimensional stability of the polymer during its conversion, which is diminished if kept at elevated temperatures for extended periods of time.

Using the protocol above for the pyrolysis appears to ensure that the process is not transport-restricted. When using the protocol above, substances are allowed to diffuse out of the polymer network slowly enough that an optimal pyrolyzed structure is formed. Diffusion is reaction-limited but not transport-limited so that the pyrolysis process allows dimensional stability during carbonisation.

As stated, high C content, low H and low O content, high aromatic content within the main chains and low generation of volatile (non carbonizable) species during thermal treatment is important.

Nitrogen (N) may be an interesting element to keep in the network as it helps in the scavenging of H from the network. Also, it is known that N, when kept in the network increases catalytic activity of the carbon, which might be beneficial for some applications.

Cooling may be effected between steps. The structure is then cooled and the thermal processing is finished.

### Amorphous Carbon Structure

In one aspect, the invention provides a geometrically predefined amorphous carbon structure that is obtainable, preferably obtained, by a process as defined herein.

In another aspect, the invention provides a geometrically predefined amorphous carbon structure having a surface area to volume ratio of 20.0 mm⁻¹ or less. In a preferred embodiment, the geometrically predefined amorphous carbon structure in this aspect is obtainable, preferably obtained, by a process as defined herein.

As used herein, the term “amorphous carbon structure” refers to a structure primarily formed of amorphous carbon. The term “amorphous” refers to the fact that the carbon structure is a non-crystalline solid i.e. lacking the long-range order that is characteristic of a crystalline material.

In one embodiment, the amorphous carbon structure comprises at least 90 wt % carbon atoms. In a preferred embodiment, the amorphous carbon structure consists essentially of carbon atoms (i.e. at least 95 wt %, preferably at least 99 wt % carbon). In a further embodiment, the amorphous carbon structure consists of carbon (i.e. approximately 100 wt % carbon).

As used herein in relation to the amorphous carbon structure, the term “geometrically predefined” refers to the fact that the amorphous carbon structure has a shape which is predetermined e.g. before the amorphous carbon structure is actually formed. In one embodiment, the amorphous carbon structure is formed according to a computer-aided design (CAD) drawing. Generally speaking, the amorphous carbon structure has a shape which is substantially identical, preferably identical, to the predetermined shape e.g. as embodied in the CAD drawing.

Where the amorphous carbon structure is obtainable or obtained by a process as defined herein, the amorphous carbon structure typically further has a shape which is substantially identical to the shape of the geometrically predefined polymeric precursor structure from which it is made. Ideally therefore, the geometrical relationships are maintained with predictable ratios. One significant way in which the amorphous carbon structure may differ from the polymeric precursor structure in this case however is that the amorphous carbon structure is typically smaller than the polymeric precursor structure. This is typically the result of shrinkage which can occur during pyrolysis. In some embodiments, this dimensional shrinkage may be up to 20% (in any given direction) such as up to 30% or 40%. In one embodiment, the shrinkage may be up to 75%. Typically, any shrinkage is predictable, e.g. it may shrink differently in different directions due to gravity and substrate constraints, but it can be accounted for by CAD. Ideally, any shrinkage is isotropic i.e. the structure shrinks by the same amount in each direction.

Shrinkage therefore is not the same as deformation.

In a preferred embodiment, the geometrically predefined amorphous carbon structure as defined herein has a surface area to volume ratio in the range of 1.0 to 20.0 mm⁻¹, preferably in the range of 2.5 to 15.0 mm⁻¹, more preferably in the range of 5.0 to 10.0 mm⁻¹.

The process of the present invention has the advantage that it can produce stable, continuous (one-piece) amorphous carbon structures in the macroscale. In one embodiment therefore, the geometrically predefined amorphous carbon structure as defined herein has at least one dimension of at least 1 cm in length, preferably in the range of 1 cm to 20 cm in length, such as 5 cm to 15 cm in length. In another embodiment, the geometrically predefined amorphous carbon structure as defined herein has at least one dimension of at least 20 cm in length, such as up to 200 cm in length.

The process of the present invention also has the advantage that it can reproduce features faithfully across several orders of magnitude, for example in the range of 100 nm to 1 cm scales. In one embodiment, the amorphous carbon structures have a resolution of as low as 100 nm, in some cases as low as 50 nm.

In one embodiment, the amorphous carbon structures have high stiffness. In one embodiment, the amorphous carbon structure has a Young's modulus of at least 5 GPa, preferably at least 10 GPa, more preferably at least 15 GPa, such as at least 20 GPa. In one embodiment, the amorphous carbon structure has a Young's modulus of up to 40 GPa, preferably up to 30 GPa.

In one embodiment, the amorphous carbon structure has a Poisson ratio in the range of 0.1 to 0.4, preferably 0.2 to 0.3.

Advantageously, the amorphous carbon structures typically have a high thermal conductivity. In one embodiment, the amorphous carbon structure has a thermal conductivity of at least 2 Wm⁻¹K⁻¹, preferably at least 4 Wm⁻¹K⁻¹, more preferably at least 5 Wm⁻¹K⁻¹. In one embodiment, the amorphous carbon structure has a thermal conductivity of up to 10 Wm 1K⁻¹, preferably up to 8 Wm⁻¹K⁻¹, more preferably up to 7 Wm⁻¹K⁻¹.

In one embodiment, the amorphous carbon structure has a density in the range of 1200 to 2200 kg/m³, preferably in the range of 1500 to 2000 kg/m³, more preferably in the range of 1600 to 1800 kg/m³.

Typically the amorphous carbon structure has a low resistivity. In one embodiment, the amorphous carbon structure has a resistivity of less than 1 Ωm, preferably less than 0.5 Ωm, more preferably less than 0.1 Ωm. In some embodiments, the amorphous carbon structure has a resistivity as low as 0.01 Ωm, preferably as low as 0.02 (m.

In one embodiment, the amorphous carbon structure has a thermal expansion coefficient in the range of 0.5×10⁻⁶ to 1×10⁻⁵ K⁻¹, preferably in the range of 1×10⁻⁶ to 5×10⁻⁶ K⁻¹.

In one embodiment, the amorphous carbon structure is in the shape of an ordered structure, such as a lattice. In a preferred embodiment, the amorphous carbon structure is a cubic lattice.

The amorphous carbon structures preferably have a low surface roughness. In one embodiment, the surface of the amorphous carbon structure is smooth.

In one embodiment, the amorphous carbon structure is continuous i.e. it is formed as a single piece. An advantage of the process of the present invention is that the structure can be free-standing i.e. no supports are required. In one embodiment, therefore, the amorphous carbon structure is formed without the use of supports. Preferably the amorphous carbon structure is formed according to a free-form CAD drawing.

### Applications

The present invention also relates to articles comprising an amorphous carbon structure as described herein. In one aspect, the invention provides an electrochemical flow device comprising a geometrically predefined amorphous carbon structure as described herein. In a preferred embodiment, the electrochemical flow device is a fuel cell, flow battery, electrolyser or heat convertor. In an especially preferred embodiment, the electrochemical flow device is a fuel cell.

In another aspect, the invention provides an electrode assembly comprising a geometrically predefined amorphous carbon structure as described herein. As used herein, the term “electrode assembly” is used to refer to a part of a cell (excluding the electrolyte) such as the anode or cathode.

In a preferred embodiment, the electrode assembly is monolithic (i.e. is formed of one piece). In an especially preferred embodiment, the electrode assembly comprises at least 90 wt % of the amorphous carbon structure, preferably at least 95 wt %. In one embodiment, the electrode assembly consists of the geometrically predefined amorphous carbon structure as defined herein. In one embodiment, the electrode assembly forms part of an electrochemical flow device as described herein. Advantageously, when the electrode assembly consists of the amorphous carbon structure, the material usage can be lower thus leading to cheaper devices.

In another aspect, the invention provides a gas diffusion layer (GDL) comprising a geometrically predefined amorphous carbon structure as described herein. Typically, the gas diffusion layer is part of an electrode assembly, which may itself be part of an electrochemical flow device as described herein. In one embodiment, the gas diffusion layer comprises at least 90 wt %, preferably at least 95 wt %, of the geometrically predefined amorphous carbon structure. In one preferred embodiment, the gas diffusion layer consists of the geometrically predefined amorphous carbon structure. In one aspect, there is provided an electrode assembly comprising a gas diffusion layer, wherein the electrode assembly consists of the geometrically predefined amorphous carbon structure.

In one aspect, the invention provides a method for producing a component of an electrode assembly, the method comprising producing a geometrically predefined amorphous carbon structure according to the process as described herein. In a preferred embodiment, the component is a gas diffusion layer. Other applications of interest include heat exchangers, carbon sensors, and gaskets.

The invention will now be further illustrated by way of the following examples and figures.

FIG. 1 is a representation of a generic pyrolysis protocol showing initial ramp, dwell and subsequent ramps that take place to produce the geometrically predefined amorphous carbon structure.

FIG. 2 is an Arrhenius plot showing a reaction limited process and transport limited process. The intersect of the lines represents the ideal holding temperature.

### EXAMPLE 1

Methods: Tg was determined using ISO11357-2 (inflection point). Td was measured by heating the geometrically predefined polymeric precursor structure at 10° C. per minute until deformation was observed using optical microscopy.

### 1. Mixing of Formulation:

a. 98.3 wt % of an 80/20 wt mixture of ethoxylated (n=3) bisphenol A diacrylate (Crosslinker)/benzyl acrylate (reactive diluent)
b. 0.2 wt % Sudan Orange (absorber)
c. 1.5 wt % Phenyl-bis-(2,4,6-trimethylbenzoyl)-phosphine oxide (BAPO) (photoinitiator)
The compounds were mixed in a rotary evaporator at 40° C. to allow for a homogeneous mix.

### 2. Photopolymerisation

The formulation prepared in step 1 was at least partially cured through selective irradiation with a digital mirror device-based UV lithography 3D printer (Solflex 650 from Way 2 Production, Austria). It has a wavelength of 385 nm.
The resulting geometrically predefined polymeric precursor structure was a flat disc of dimensions 4 cm×4 cm porous media of cubic lattice form with beams of ˜10 μm after carbonization. The height was 2 mm.

### 3. Washing

The cured photopolymer was developed by washing with isopropanol and acetone in a sequence of wash cycles in order to remove any residual (uncured) formulation.

### 4. Post-Curing

The washed photopolymer from step 3 was placed in a curing chamber with a UV lamp of type Phoseon RX Fireline 395 LED with 8 W/cm² intensity for 1 hour to fully cure the photopolymer (i.e. to convert the residual monomers within the polymeric structure that did not yet react).
The resulting material has a glass transition temperature Tg of 105° C. and a degradation temperature Td of about 400° C.

### 5. First Carbonisation Step

The cured photopolymer from step 4 was heated from room temperature to 350° C. (i.e. above its Tg) in inert atmosphere (N₂ quality 5.0) at a ramp rate of 2° C./min and kept at this temperature for 10 hours until the mass loss stagnates, i.e. until it is stable. During this step the cured photopolymer is suspended between two carbon fibre mats in order to retain its mechanical stability (i.e. to prevent buckling and creep). At this stage, the cured photopolymer loses non-carbonisable species such as H₂O, CO₂, and longer chain hydrocarbons. The photopolymer was subsequently cooled down to room temperature.

### 6. Flattening Step

The cooled material received from step 5 was removed from the carbon fibre mat and placed between two thermally conductive aluminium plates. It was then heated on a hot plate in air to 400° C. and kept at this temperature for 10 minutes until the top and bottom faces of the material parallelize (flatten) due to the load from the aluminium plates. The flattened structure was subsequently cooled down to room temperature and removed from the aluminium plates.

### 7. Second Carbonisation Step

The partly carbonized structure received from step 6 was placed between two carbon fibre mats again and placed in an oven with inert atmosphere (N₂ quality 5.0). The temperature was then raised from room temperature to a temperature in the range of 900 to 1000° C. at a ramp rate of 5° C./min to complete the carbonization. In this step mostly H₂ disappears from the polymer network and rearrangement (cyclization) to amorphous carbon occurs. The structure is cooled down to room temperature and removed from the carbon fibre mats.
The resulting amorphous carbon structure is of high quality, has a predictable geometry, a low surface area to volume ratio (less than 20.0 mm⁻¹), sub-micron resolution, and low surface roughness.

### EXAMPLE 2

A cured photopolymer was prepared as described in steps 1 to 4 above. The cured photopolymer was heated in an inert atmosphere at 2° C. per minute from ambient temperature to a holding temperature of 320° C. and held at that temperature for 10 hrs.

Thereafter the photopolymer was further heated at a ramp of 1° C. per minute to a temperature of 500° C. The ramp was then increased to 3° C. per minute up to a temperature of 1000° C.

In a second embodiment, after holding for 10 hrs, the photopolymer was heated at 3° C. per minute to 1000° C.

In a third embodiment, after holding for 10 hrs, the photopolymer was heated at 3° C. per minute until 500° C. and thereafter at 5° C. per minute to 1000° C.

1. A process for the production of a geometrically predefined amorphous carbon structure, comprising:
i) forming a geometrically predefined polymeric precursor structure; and
ii) pyrolysing said geometrically predefined polymeric precursor structure so as to form said geometrically predefined amorphous carbon structure;
wherein step i) comprises forming a geometrically predefined polymeric precursor structure on a substrate, said geometrically predefined structure comprising an at least partially cured photopolymer;
and wherein the step ii) of pyrolysing said geometrically predefined polymeric precursor structure comprises:
(a) holding the geometrically predefined polymeric precursor structure at a temperature in the range of 200° C. to 400° C. for a period of between 1 hour and 40 hours, preferably 5 hours to 20 hours; and
(b) subsequently pyrolysing said geometrically predefined polymeric precursor structure at a temperature of 700° C. to 1200° C.

2. A process for the production of a geometrically predefined amorphous carbon structure, comprising:
i) forming a geometrically predefined polymeric precursor structure; and
ii) pyrolysing said geometrically predefined polymeric precursor structure so as to form said geometrically predefined amorphous carbon structure;
wherein step i) comprises forming a geometrically predefined polymeric precursor structure on a substrate, said geometrically predefined polymeric precursor structure comprising an at least partially cured photopolymer;
wherein said cured photopolymer has a glass transition temperature (T_{g}) in ° C. and the geometrically predefined polymeric precursor structure has a heat degradation temperature (T_{d}) in ° C. such that T_{d} is at least 300° C. and T_{d} is greater than the T_{g}.

3. A process as claimed in any preceding claim, wherein the geometrically predefined polymeric precursor structure is formed by an additive manufacturing method, preferably by 3D printing.

4. A process as claimed in any preceding claim, wherein the geometrically predefined polymeric precursor structure is formed by two-photon polymerisation, digital light processing UV photopolymerisation, or stereolithography.

5. A process as claimed in any preceding claim, wherein the step of forming said geometrically predefined polymeric precursor structure comprises the steps of:
a) forming on a substrate, a layer of material comprising a formulation comprising an oligomeric multifunctional monomer, photoinitiator and optionally a reactive diluent;
b) selectively projecting light from a light source onto said layer, e.g. via a digital micromirror device, causing said formulation to at least partially cure in the areas of said layer exposed to said light; and
c) optionally repeating steps a) and b).

6. A process as claimed in any preceding claim, wherein the cured photopolymer is a thermoset.

7. A process as claimed in any preceding claim, wherein the cured photopolymer comprises the residue of a multifunctional (meth)acrylic monomer, such as an multifunctional aromatic (meth)acrylic monomer.

8. A process as claimed in any preceding claim, wherein the cured photopolymer comprises the residue of 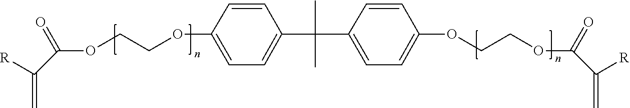
where each n is 0 to 40, such as 2 to 30, preferably 3 to 10 and each R is H or methyl.

9. A process as claimed in any preceding claim, wherein the glass transition temperature of the cured photopolymer is in the range of 80° C. to 200° C.

10. A process as claimed in any preceding claim, wherein the degradation temperature of the geometrically predefined polymeric precursor structure is in the range of 350° C. to 450° C.

11. A process as claimed in any preceding claim, wherein the difference between the glass transition temperature of the cured photopolymer and the Td of the geometrically predefined polymeric precursor structure is 200° C. or more.

12. A process as claimed in any preceding claim, wherein the cured photopolymer has a ratio of carbon atoms to oxygen atoms (C/O) of at least 2:1, preferably at least 3:1, more preferably at least 4:1.

13. A process as claimed in any preceding claim, wherein the cured photopolymer has a ratio of carbon atoms to hydrogen atoms (C/H) of at least 1:3, preferably at least 1:2, more preferably at least 1:1.

14. A process as claimed in any preceding claim, wherein the cured photopolymer has a carbon content of at least 30 at. %, preferably at least 40 at. %, more preferably at least 50 at. %.

15. A process as claimed in any preceding claim, wherein the cured photopolymer has a ratio of sp² to sp³ hybridised carbon atoms of at least 1:2, preferably at least 1:1, more preferably at least 2:1.

16. A process as claimed in any preceding claim, wherein the cured photopolymer consists essentially of C, H and O atoms.

17. A process as claimed in any preceding claim, wherein the step of pyrolysing said geometrically predefined polymeric precursor structure comprises heating the geometrically predefined polymeric precursor structure to a temperature in the range of 700° C. to 1200° C.

18. A process as claimed in any preceding claim, wherein the step of pyrolysing said geometrically predefined polymeric precursor structure comprises holding the geometrically predefined polymeric precursor structure at a temperature in the range of 200° C. to 400° C. for a period of between 1 hour and 40 hours, preferably 5 hours to 20 hours.

19. A process as claimed in any preceding claim, wherein the step of pyrolysing said geometrically predefined polymeric precursor structure comprises (a) holding the geometrically predefined polymeric precursor structure at a temperature in the range of 200° C. to 400° C. for a period of between 1 hour and 40 hours, preferably 5 hours to 20 hours and (b) subsequently pyrolysing said geometrically predefined polymeric precursor structure at a temperature of 700° C. to 1200° C.

20. A process as claimed in any preceding claim, wherein the process further comprises a post bake step between steps (i) and (ii) such as a UV post-bake step.

21. A process as claimed in any preceding claim wherein the pyrolysis step (ii) is effected according to the following protocol:
a. 2-5° C./min ramp to a holding temperature of 200 to 400° C., preferably 300 to 400° C.;
b. hold at the holding temperature for 1 to 40 hrs, such as 8 to 20 hrs;
c. 0.5-7.5° C./min ramp from the holding temperature, such as 0.5 to 5° C./min ramp, to a temperature in the range of 450 to 600° C.;
d. 2.5 to 10° C./min ramp from the temperature in step 3 to 900° C. or more;
preferably wherein, the ramp in step d. is the same as or faster than the ramp in step c.

22. A process as claimed in any preceding claim wherein the at least one cured photopolymer forms at least 90 wt % of the geometrically predefined polymeric precursor structure, such as at least 95 wt %, of the at least one cured photopolymer.

23. A geometrically predefined amorphous carbon structure obtainable, preferably obtained, by a process as claimed in any preceding claim, e.g. having a surface area to volume ratio of 20.0 mm⁻¹ or less.

24. A geometrically predefined amorphous carbon structure according to claim 23 having a surface area to volume ratio in the range of 1.0 to 20.0 mm⁻¹, preferably in the range of 2.5 to 15.0 mm⁻¹, more preferably in the range of 5.0 to 10.0 mm⁻¹.

25. A geometrically predefined amorphous carbon structure according to any of claims 23 to 24, having at least one dimension of at least 1 cm in length, preferably in the range of 1 cm to 20 cm in length.

26. An electrochemical flow device comprising a geometrically predefined amorphous carbon structure as claimed in any of claims 23 to 25, preferably wherein the electrochemical flow device is a fuel cell, flow battery, electrolyser or heat convertor, more preferably a fuel cell.

27. An electrode assembly comprising a geometrically predefined amorphous carbon structure as claimed in any of claims 23 to 25.

28. A gas diffusion layer, heat exchanger, carbon sensor, or gasket comprising a geometrically predefined amorphous carbon structure as claimed in any of claims 23 to 25.

29. A method for producing a component of an electrode assembly, preferably a gas diffusion layer, comprising producing a geometrically predefined amorphous carbon structure according to the process of any of claims 1 to 22.
